(19) United States
(12) Patent Application Publication
(10) Pub. No.: US 2005/0190165 A1
(43) Pub. Date: Sep. 1, 2005

(54) Display panels, display units and data processing assemblies

(76) Inventor: Philippe Wendling, Coublevie (FR)

Correspondence Address: Richard P. Berg, Esq.;c/o LADAS & PARRY, Suite 2100, 5670 Wilshire Boulevard, Los Angeles, CA, 90036-5679, US

(21) Appl. No.: 10/676,714

(22) Filed: Sep. 30, 2003

(30) Foreign Application Priority Data
Oct. 2, 2002 (EP) 02354149.3

(51) Int. Cl. G09G 5/00

(52) U.S. Cl. 345/204

(57) ABSTRACT

Original design manufacturers increasingly source standard components from a variety of suppliers. There is a need to maintain the variety of suppliers as having only a single supplier for a component runs the risk of a demand for that component not being met and the risk that the technology for the component may move on while a current supplier's technology remains unchanged. Obtaining various components from different suppliers bears the problem that not all of the components are guaranteed to operate in an identical manner. Manufacturing tolerances often result in the obtained components having different performances. In the case of a flat panel display such as, for example, an LCD panel, these manufacturing performance differences may manifest themselves in colour variations as between LCD panels. This is clearly undesirable from the perspective of the original design manufacturer. This problem has been addressed in the past by providing tailored firmware for each of the display devices that takes into account the variations in the characteristics of the display devices. This approach bears significant manufacturing and support penalties. Suitably, embodiments of the present invention provide a display unit having associated operational data that allows firmware to take into account the specific characteristics of a flat panel display of that unit when rendering video data or signals.

### FIELD OF THE INVENTION

The present invention relates to display panels, display units and data processing assemblies.

### BACKGROUND TO THE INVENTION

Manufactures of computers often source components for those computers from various component vendors. The components include, for example, monitors and, in particular, LCD panels for incorporation into laptop computers or LCD displays. Due to manufacturing tolerances, the LCD panels may exhibit different or varying display characteristics. This may be the case as between batches of LCD panels obtained from the same manufacturer and the problem may be exacerbated in relation to LCD panels fabricated by different manufacturers. However, original design manufacturers (ODM) cannot present end users or customers with batches of equipment having different display characterstics. This is especially applicable to the supply of large numbers of displays, or computers having such displays, to corporations where any variation in performance or characteristics as between displays may be more noticeable.

ODMs have addressed this problem in the past by producing firmware that is suitable for driving respective display panels. Each of the firmware is tailored to the specific needs of a display panel to be driven. Therefore, the display panels can be made to operate in a consistent mariner notwithstanding any inherent differences or variations that may arise as between batches of display panels or as between manufacturers of display panels. However, having such tailored firmware increases manufacturing and support costs.

It is an object of embodiments of the present invention at least to mitigate some of the problems of the prior art.

### SUMMARY OF THE INVENTION

Accordingly, a first aspect of embodiments of the present invention provides a display unit comprising a specific display panel, of a class of display panels, having associated display panel characteristics that influence visual performance of that specific display panel; the display having first storage comprising generic data, common to the class of display panels, for influencing the operation of the display unit and specific data tailored to the associated specific display panel characteristics; and a controller for executing firmware that is responsive to the specific data to influence the visual performance of the specific display panel.

Preferred embodiments provide a display unit in which the display unit comprises a housing such that at least the display panel, first storage and controller are at least partially housed within the housing.

Embodiments provide a display unit in which the display unit forms part of a subsystem of a computer system; the subsystem comprising at least the display panel, the first storage and the controller.

Preferably, embodiments provide a display unit in which the firmware is common to, and identical across, the class of display panels.

It will be appreciated that the manufacturing tolerances of processes very. Suitably, embodiments provide a display unit in which each display panel of the class of display panels has respective associated display panel characteristics.

A second aspect of embodiments of the present invention provides a display unit comprising a flat panel display; a standard video interface for exchanging video and data signals with a standard video card, display driver means to process the video signals to drive the flat panel display to produce an image from the video signals; storage means comprising first data for output to a host computer via the standard video interface relating to the operation of the display unit and flat panel display data relating to operational characteristics of the flat panel display; the flat panel display data being used by the display driver means to influence the operation of the flat panel display in producing said image.

Advantageously, a microcontroller of the display unit or, for example, of a graphics card or video card can read the operational data associated with the display device and use that data to drive the controllers of the display device appropriately.

Embodiments of the present invention at least reduce, and preferably remove, the need to provide tailored firmware for driving the display panels. A single instance or version of a universally applicable firmware can be used to drive the display panels in conjunction with very particular respective operational parameters or data associated with the various display panels.

Preferably, the respective operational data relates to at least one of a manufacturer identification code, a product code, a serial number, date data, a version code, a revision code, input data signal type, screen geometry data, a gamma value, feature support data and panel colour temperature. In preferred embodiments, the input data signal type provides an indication of the supported signal protocol for data communication between the scaler/timing controller and the flat panel display drivers. The screen geometry data comprises an indication of the maximum horizontal and vertical screen sizes that can be accommodated by the display device. Also, in preferred embodiments, the panel colour temperature comprises Red, Green, and Blue coordinates of a reference colour. Preferably, the reference colour is white at a temperature of 6500 Kelvin.

Embodiments of the present invention provide a method of manufacturing first and second display units; the first display unit having a first display panel with operational characteristics specific to that first display panel and the second display unit having a second display panel with second operational characteristics specific to that second display panel; each unit bearing a standard video interface for outputting and receiving video and data signals; each display unit comprising first non-volatile storage for storing generic data accessible via the standard video interface; the generic data being used to influence the operation of the display units; the method comprising the steps of establishing respective sets of parameters for controlling the operation of the display panels so that the display panels perform to thin common tolerances; the parameters being tailored to the respective operational characteristics; storing the respective sets of parameters within respective second non-volatile storage of the display units; programming respective first non-volatile storage devices of the first and second display units with common firmware that is responsive to the respective sets of parameters to control the operation of the respective display panels to within the common tolerances.

Furthermore, embodiments of the present invention provide a method of manufacturing first and second computer systems; the first computer system comprising a display panel having first operational characteristics and the second computer system comprising a display panel having second operational characteristics; the method comprising the steps of establishing respective sets of parameters for controlling the operation of the display panels so that the display panels operate to within common tolerances; the parameters being tailored to the respective operational characteristics; storing the respective sets of parameters within non-volatile storage media of the display panels; programming respective non-volatile storage panels of the first and second computer systems with common firmware that is responsive to the respective sets of parameters to control the operation of the display panels to within the common tolerances.

Still further embodiments provide a method of manufacturing first and second computer systems having respective display units comprising respective non-volatile storage devices containing respective operational data to control the operation of the display panels of the display units to within common tolerances; the method comprising the step of programming respective non-volatile storage devices of the first and second computer systems with common firmware that is responsive to the respective sets of parameters to control the operation of the display panels of the display units respectively.

### BRIEF DESCRIPTION OF THE DRAWINGS

Embodiments of the present invention will now be described, by way of example only, with reference to the accompanying drawings in which:

FIG. 1 shows, schematically, a flat panel display unit according to an embodiment; and

FIG. 2 shows a data structure containing data used by the first embodiment.

### DETAILED DESCRIPTION OF PREFERRED EMBODIMENTS

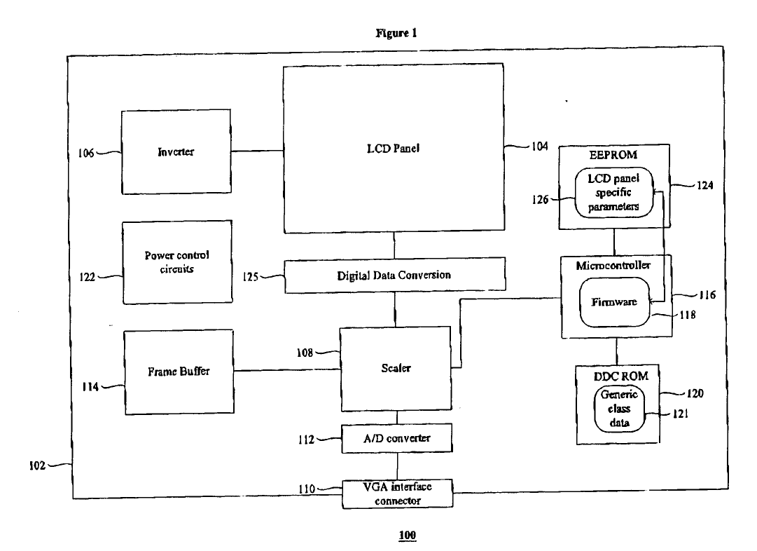

FIG. 1 shows a schematic diagram of the main functional components of a flat panel display unit 100. The display unit 100 comprises a panel enclosure 102, having a shallow rectangular shape. The panel enclosure 102 house a flat panel display such as, for example, an LCD display panel 104, together with its associated back-light and inverter 106. The display unit 100 also comprises various video signal processing components, such as, for example, a scaler 108 for changing the pixel resolution of a digitally encoded image (not shown), a standard video interface, in the form of, for example, a VGA interface 110, including a standard VGA connector for exchanging signals, via a flying lead, with a computer system unit (not shown), and analogue-to-digital conversion and frame rate conversion circuitry 112. A RAM 114, forming a frame buffer, is used by the scaler 108 for temporarily storing image data of an image to be displayed on the panel to enable Frame Rate Conversion.

The display unit 100 also includes a microcontroller 116, which includes firmware 118 to manage the functions of the display unit 100, such as video timing, communication with the scaler 108, and tee generation of menus and other visible indications (not shown) displayable on the LCD panel 104. This functionality is generally referred to as on-screen display (OSD). The microcontroller 116 and scaler 108 constitute part of display driver means for driving the flat panel display 104.

A DDC ROM 120 stores standardised Extended Display Identification Data information and makes that information available to the computer system unit (not shown) via the VGA interface 110 in accordance with the well known display data channel DDC standards. The data contained within the DDC ROM 120 is generic data in the sense that it need not necessarily be tailored to the specific performance or characteristics of any single display panel of a class of display panels. Preferably, power control circuits 122, which include suitable DC-DC converters, are located within the display unit 100.

The panel enclosure 102 also comprises further non-volatile storage in the form of for example, an EEPROM 124 that stores data 126 relating to the specific characteristics of the LCD panel 104. The data 126 is used to enable the microcontroller to take the specific characteristics of the display panel 104 into account when controlling the various electronics to produce an image from the video signals received via the VGA interface 110. It will be appreciated that the LCD panel 104 will be one of a class of LCD panels; all of which are intended to perform in a substantially similar manner. However, duo to manufacturing tolerances, the actual performance of the panels of any given class varies.

Usually, the ODM of the display unit 100 will buy the display panels from other suppliers and the detailed designs may vary as between different suppliers. Even if the manufacturer of the display unit 100 also manufactures the display panels, the design of the display panels may evolve over time. The data 126 stored in the EEPROM 124 provides a means for the microcontroller 116 to discover the type of flat panel display present and to adapt its operation, via the firmware 118 and data 126, accordingly.

As indicated above, the microcontroller 116 is arranged to execute firmware 118 to influence the operation of the scaler and timing controller 108 and the inverter 106 and, ultimately, the LCD panel 104. Accordingly, a single, or universal, version of the firmware 118 can be developed for driving a number of marginally different types of LCD panel or a number of different types of flat panel displays notwithstanding any variations in the technical or operational performance of those display panels that may have arisen due to manufacturing tolerances or due to differences that can be attributed to different manufacturers.

For example, the scaler and timing controller 10 is driven by the firmware 118 according to the refresh rate set for the LCD panel 104 as well as the screen geometry, that is, the maximum horizontal and vertical viewable area of the screen 106 and appropriate reference colour temperature coordinates for a reference colour with a colour space. The reference colour may be, for example, white at 6500 Kelvin in an RGB colour space.

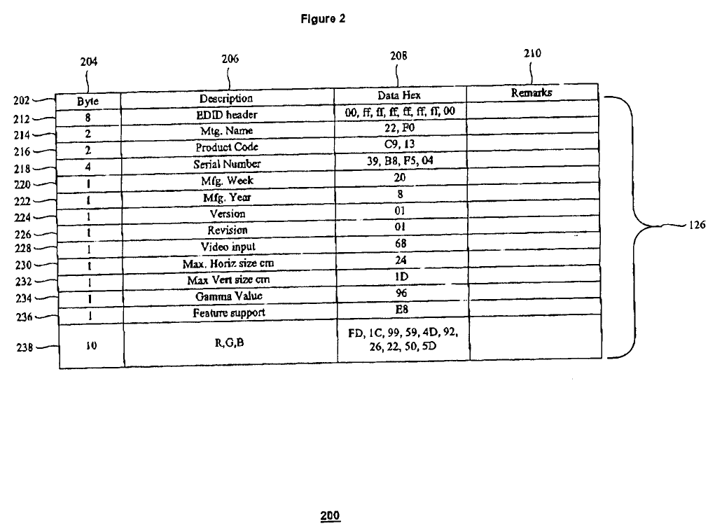

Referring to FIG. 2, there is shown a table 202 representing possible data 126 described with reference to FIG. 1. The table 202, in the illustrated example, has a byte column 204, a description column 206, a data value column 208 and a remarks column 210. The byte column 204 stores an indication of the number of bytes contained within the data value column 208 that are relevant to a respective parameter. Therefore, a data value column entry contains a number of bytes of data that corresponds to the values contained within the respective byte column 204. The data in the data value column 208 are used as input parameters for the firmware 118.

Some of the various columns are optional and have been illustrated for purposes of understanding. For example, the byte column 204, the description column 206 and the remarks column 210 are optional and can be used to provide an indication of the type of data contained within the data value column 208 and to make comments in relation to that data or to assist in accessing that data.

In the illustrated example, the first row 212 is used to store header data for the table. The second row 214 is used to store data identifying the manufacturer of the display unit or part of the display unit such as, for example, the flat panel display. The data comprises two bytes. The third row 216 is used to store two bytes that represent a product code identifying the product relating to the data contained within the table 202. The fourth row 218 is used to store four bytes of data that represent a serial number of the product. The fifth row 220 is used to store, using a single byte, an indication of the week in which the product was manufactured. The sixth row is used to store an indication of the year of manufacture of the product using a single byte. The seventh row is used to store, using a single byte, the version of the product. The eighth row 226 is used to store an indication of the revision number of the product wing a single byte. The ninth row 228 stores, in a single byte, an indication of the refresh rate required by the display panel 104. The tenth row 230 stores, using a single byte, an indication of the maximum horizontal size of a viewable area of the display panel 104. Similarly, the eleventh row 232 stores the corresponding vertical size of the viewable area of the display panel 104. A gamma value is stored, using a single byte, in the twelfth row 234 of the table 202. In the thirteenth row 236 an indication of additional features supported by the display unit 100 stored using a single byte. The supported features may include, for example, power saving modes of operation. The fourteenth row 238 is used to store, in ten bytes, the R, G, B coordinate for a reference colour of white at a temperature of 6500 Kelvin degree.

Although the above embodiment has been described with reference to an RGB colour space, embodiments of the invention are not limited thereto. Embodiments can be realised in which some other colour space, such as, for example, HUV, is used instead.

The above embodiment has been described with reference to the display unit 100 having a VGA interface. However, embodiments are not limited to such an interface. Embodiments can be realised in which the video interface is an EGA, SVGA, XGA, SXGA or UXGA interface as are well known within the art.

Although the above embodiments have been described with reference to the flat panel display being an LCD display, other types of flat panel display can also be used. For example, a plasma flat panel display may be used.

The use of separate non-volatile storage means to store the generic and specific data for the panels is not essential. Embodiments can be realised in which common non-volatile storage is used to store both the generic and specific data.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Alternative features serving the same, equivalent or similar purpose may replace each feature disclosed in this specification, including any accompanying claims, abstract and drawings, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A display unit comprising a specific display panel, of a class of display panels, having associated display panel characteristics that influence visual performance of that specific display panel; the display having first storage comprising generic data, common to the class of display panels, for influencing the operation of the display unit and specific data tailored to the associated specific display panel characteristics; and a controller for executing firmware that is responsive to the specific data to influence the visual performance of the specific display panel.

2. A display unit as claimed in claim 1 in which the display unit comprises a housing such that at least the display panel, first storage and controller are at least partially housed within the housing.

3. A display unit as claimed in claim 1 in which the display unit forms part of a subsystem of a computer system; the subsystem comprising at least the display panel, the first storage and the controller.

4. A display unit as claimed in claim 1 in which the firmware is common to, and identical across, the class of display panels.

5. A display as claimed in claim 1, in which each display panel of the class of display panels has respective associated display panel characteristics.

6. A display unit comprising a flat panel display, a standard video interface for exchanging video and data signals with a standard video card, display driver means to process the video signals to drive the flat panel display to produce an image from the video signals, storage means comprising first data for output to a host computer via the standard video interface relating to the operation of the display unit and flat panel display data relating to operational characteristics of the flat panel display; the flat panel display data being used by the display driver means to influence the operation of the flat panel display in producing said image.

7. A display unit as claimed it claim 8 in which the flat panel display is an LCD panel.

8. A display unit as claimed in claim 6 in which the standard video interface and standard video card complies with one the VGA, SVGA, XGA, SXGA and UXGA standards.

9. A display unit as claimed in claim 6 in which the flat panel display data comprises data relating to at least colour temperature within a corresponding colour space.

10. A display unit as claimed in claim 9 in which the colour temperature data comprises coordinates within the corresponding colour space of a reference colour.

11. A display unit as claimed in claim 10 in which the reference colour is white at a colour temperature of 6500 Kelvin.

12. A display unit as claimed in claim 6 in which the display driver means comprises at least a microcontroller to run firmware, responsive to the flat panel display data and common to a class of flat panel displays, to influence the operation of the flat panel display.

13. A data processing assembly comprising a computer system unit and a display unit as claimed in claim 1.

14. A display panel comprising a flat panel display, of a class of flat panel displays, and first storage, both mounted to a display panel support; the first storage comprising at least specific data, tailored to associated flat panel display characteristics, for use in influencing the operation of the flat panel display when processed by a controller forming part of a subsystem of which the display panel will form an integral part.

15. A display panel as claimed in claim 14 in which the flat panel display is an LCD panel.

16. A method of manufacturing first and second display units; the first display unit having a first display panel with operational characteristics specific to that first display panel and the second display unit having a second display panel with second operational characteristics specific to that second display panel; each unit bearing a standard video interface for outputting and receiving video and data signals; each display unit comprising first non-volatile storage for storing generic data accessible by the standard video interface; the data being used to influence the operation of the display units; the method comprising the steps of establishing respective sets of parameters for controlling the operation of the display panels so that the display panels perform to within common tolerances; the parameters being tailored to the respective operational characteristics; storing the respective sets of parameters within respective second non-volatile storage of the display units; programming respective first non-volatile storage devices of the first and second display units with common firmware that is responsive to the respective sets of parameters to control the operation of the respective display panels to within the common tolerances.

17. A method of manufacturing first and second computer systems; the first computer system comprising a display device having first operational characteristics and the second computer system comprising a display device having second operational characteristics; the method comprising the steps of
establishing respective sets of parameters for controlling the operation of the display devices so that the display devices operate to within common tolerances;
storing the respective sets of parameters within non-volatile storage media of the display devices;
programming respective non-volatile storage devices of the first and second computer systems with common firmware that is responsive to the respective sets of parameters to control the operation of the display devices to within the common tolerances.

18. A method of manufacturing first and second computer systems having respective display units comprising respective non-volatile storage containing respective operational data to control the operation of the display devices to within common tolerances; the method comprising the step of programming respective non-volatile storage of the first and second computer systems with common firmware that is responsive to the respective sets of parameters to control the operation of the display unit respectively.
